(19) United States
(12) Patent Application Publication
(10) Pub. No.: US 2019/0225128 A1
(43) Pub. Date: Jul. 25, 2019

(54) BLADDER FILLABLE WITH PRESSURE MEDIUM AS AN ADJUSTMENT ELEMENT FOR A SEAT, AND METHOD FOR PRODUCING THE BLADDER

(71) Applicant: Conti Temic Microelectronic GmbH, Nürnberg (DE)

(72) Inventors: Johann Steinberger, Brunnen (DE); Wolfgang Thiel, Denkendorf (DE); Thomas Schütze, Paunzhausen (DE)

(73) Assignee: Conti Temic Microelectronic GmbH, Nurnberg (DE)

(21) Appl. No.: 16/317,180

(22) PCT Filed: Aug. 1, 2017
(86) PCT No.: PCT/EP2017/069468

§ 371 Date: Jan. 11, 2019

(30) Foreign Application Priority Data
Aug. 5, 2016 (DE) 10 2016 214 529.0

(51) Int. Cl. B60N 2/90

(52) U.S. Cl. CPC B60N 2/914; B29C 65/04

(57) ABSTRACT

To produce a bladder which can be filled with pressure medium, a one-piece hose-like bladder body is provided with a casing surface which extends from a first end portion to a second end portion and encloses a bladder chamber. Furthermore, a pressure medium line is introduced into the bladder chamber in particular through the first or the second end portion. Finally, at least one joint connection is produced for closing the open end portions so as to form a bladder chamber sealed against pressure medium. By using a hose-like bladder body as the base body for the bladder, the manufacturing complexity for production is minimized.

### CROSS REFERENCE TO RELATED APPLICATIONS

This application is the U.S. National Phase Application of PCT International Application No. PCT/EP2017/069468, filed Aug. 1, 2017, which claims priority to German Patent Application No. 10 2016 214 529.0, filed Aug. 5, 2016, the contents of such applications being incorporated by reference herein.

### FIELD OF THE INVENTION

The present invention concerns a bladder which can be filled with pressure medium as a (pneumatic) actuating element for a seat, in particular a vehicle seat. The present invention also relates to a method for producing the bladder which can be filled with pressure medium.

### BACKGROUND OF THE INVENTION

In modern vehicle seats, bladders which can be filled with a pressure medium, in particular with a gaseous pressure medium such as compressed air, are situated as actuating elements in the region of the seat surface or backrest (together also referred to as the seat bearing surface), and can be supplied with pressure medium via a respective pressure medium line. By filling a respective bladder with pressure medium, its volume is increased so that the properties of a seat backrest or surface in relation to the contour can be changed. For filling the respective bladder with pressure medium, the pressure medium is firstly generated by a pressure medium source, for example by a compressor or a compressor unit, and guided via a corresponding valve, in particular an electropneumatic valve of a control unit, to a respective bladder.

It is conceivable that an arrangement described above may be produced from one or more bladders with respective assigned pressure medium lines. It is here conceivable that the respective bladders are produced from two or more separate flexible films, wherein to form a respective bladder, the films must first be correctly placed relative to each other and then welded together at a connecting seam. In particular in pneumatic adjusting devices with a plurality of bladders, the manufacturing complexity for producing such an adjusting device for adjusting the contour of a vehicle seat is high.

### SUMMARY OF THE INVENTION

An aspect of the present invention aims to create a possibility of minimizing the manufacturing complexity for producing an actuating element for a seat, in particular a vehicle seat.

According to a first aspect of the invention, a bladder is created which can be filled with pressure medium and which may serve as an actuating element for a seat, in particular a vehicle seat. Here, the bladder which can be filled with pressure medium has a one-piece hose-like bladder body with a casing surface which extends from a first end portion to a second end portion and encloses a bladder chamber. Furthermore, the bladder which can be filled with pressure medium has at least one joint connection for closing the end portions so as to form a bladder chamber which is sealed against fluid or pressure medium. Here, a pressure medium line is provided for introducing pressure medium into the fluid-tight bladder chamber. The pressure medium line may also serve to evacuate the pressure medium from the bladder chamber. Due to the use of a hose-like bladder body (as a starting material), a favorable bladder can be achieved as an actuating element for the vehicle seat, since the manufacturing complexity for production is minimized. A complex positioning of films relative to each other is no longer required, and merely the end portions need be closed to form a bladder chamber.

In this context, the term “one-piece” bladder body means that the bladder body is made from a single piece.

According to one embodiment of the bladder which can be filled with pressure medium, the pressure medium line is provided such that it is introduced through at least one of the end portions at the at least one joint connection. In this way, in turn a possibility is created for introducing the pressure medium line with little manufacturing complexity. Secondly, because the pressure medium line is introduced at an end portion, a good seal of the bladder chamber can be achieved even in the region of the pressure medium line.

According to a further embodiment of the bladder which can be filled with pressure medium, the hose-like bladder body can be produced in an extrusion process and in particular consists of an extruded semifinished product. This is preferably made from a thermoplastic material or a thermoplastic plastic. In particular, it is advantageous to make the hose-like bladder body from a flexible material of which the shape can be changed; this is possible for example with a thermoplastic plastic.

According to a further embodiment of the bladder which can be filled with pressure medium, the joint connection is a weld connection which in particular is produced by means of high-frequency welding. It is however also conceivable to produce a different type of joint connection, for example a joint connection by gluing.

According to a second aspect of the invention, a method is created for producing a bladder which can be filled with pressure medium and which may serve as an actuating element for a seat, in particular a vehicle seat. Here, in a first step, a one-piece hose-like bladder body is provided with a casing surface which extends from a first open end portion to a second open end portion and encloses a bladder chamber. Furthermore, a pressure medium line is provided for introducing or evacuating a fluid into or from the bladder chamber. In addition, at least one joint connection is produced for closing the open end portions so as to form a fluid-tight bladder chamber. By using a one-piece hose-like bladder body in which the casing surface is already formed to surround a bladder chamber, the manufacturing complexity for producing a fluid-tight bladder chamber, and hence for producing an actuating element for a vehicle seat, is low. In addition, by connecting a hose with the desired width of the hose-like bladder body, a defined size of the bladder or bladder chamber to be produced can easily be established. In contrast to production of a bladder chamber from two films connected one above the other to enclose the bladder chamber, in the method depicted little waste material is produced, since for example no punching steps are required for producing the films. According to an advantageous embodiment of the method according to the second aspect, on provision of the pressure medium line, this is introduced through at least one of the two open end portions. In this way, on production of the joint connection, this joint connection may also serve to seal the pressure medium line against the hose-like bladder body. Thus firstly the bladder body is produced as such, and at the same time the pressure medium line in the bladder chamber is produced so as to be sealed against fluid or pressure medium. It is furthermore conceivable that not only is one pressure medium line introduced into the bladder chamber, but also two or more. The pressure medium lines may be introduced either only at one open end portion or also at both end portions. In particular, it must be ensured that an end portion of the pressure medium line opens into the bladder chamber so that fluids can be exchanged between the bladder chamber and the environment.

According to a third aspect of the invention, a method is created for producing a bladder which can be filled with pressure medium and which may serve as an actuating element for a seat, in particular a vehicle seat. In contrast to the method according to the second aspect in which a hose-like body with the dimensions of the later bladder is used, the principle of the method according to the third aspect lies in starting initially from a hose-like base body which then, after various method steps, ends in a hose-like bladder body. Here, initially the hose-like base body is provided with a first open end portion, a second portion remote from the first open end portion, and a casing surface which joins the two portions together and encloses a bladder chamber. Here, the casing surface in particular constitutes a part of the base body in the region of the first end portion of the base body. Furthermore, a pressure medium line is provided for introducing or evacuating the pressure medium into or from the bladder chamber. In addition, at least one joint connection is produced for closing the first open end portion and the second portion so as to form a bladder chamber which is sealed against fluid or pressure medium. Finally, a (hose-like) bladder body surrounding the sealed bladder chamber is separated from the hose-like base body. Here, the separation may be made in particular along the joint connection, whereby fewest waste products occur in production. It is however also conceivable to make the separation inside the joint connection or adjacent thereto. In this way in turn, a simple method is created with minimal manufacturing complexity for producing a bladder with a hose-like bladder body, in which, starting from the hose-like base body, an actuating element for a vehicle seat can be produced by production of the joint connection and subsequent separation of a finished bladder.

According to one embodiment of the method, on provision of the pressure medium line, the pressure medium line is introduced into the bladder chamber through the first open end portion. In this way it is again possible, on production of the joint connection for closing the bladder chamber, at the same time to also create a good seal between the pressure medium line and the hose-like base body.

According to one method of introducing the pressure medium line, this is introduced through the open end portion such that the hose-like base body is movable relative to the fixed pressure medium line when the pressure medium line is fixed. In this way, the hose-like base body, for example in the form of an extruded plastic hose, may be wound on a drum and correspondingly, by unwinding the drum, the first open end portion can easily be moved in the direction of the fixed pressure medium line. This ensures that the pressure medium line remains in the predefined position in the joining process, and hence guarantees a high process reliability.

According to one embodiment of the method according to the third aspect, the hose-like base body may be formed as one piece. In particular, the hose-like bladder body or the hose-like base body may be produced by means of an extrusion process. For example, the hose-like bladder body and the hose-like base body may then be made from a thermoplastic plastic. In this way, in a simple and favorable fashion, it is possible to create a flexible bladder which can be filled with pressure medium, and the volume of which can be changed by filling with pressure medium so that, as an actuating element, it can exert an influence on the contour of a vehicle seat.

According to a further embodiment of the method of the second and third aspects, the joint connection is produced by means of welding, in particular by means of high-frequency welding. In particular, a separated joint connection may be made at both the open first portion and at the second portion in order to produce a sealed bladder chamber. It is however also conceivable to produce a sealed bladder chamber by means of a peripheral joint connection, for example by use of a peripheral die-shaped electrode on welding.

According to a further embodiment of the two methods according to the second and third aspects, one or more passage openings or holes may be provided in the bladder or the hose-like bladder body. It is conceivable in particular to form these passage openings or holes in the region of the joint connection. It is however also conceivable that a hose-like bladder body or a hose-like base body is already formed with a corresponding fixing portion in which the holes are later provided. Here it is conceivable that the holes are formed by punching.

Advantageous embodiments of the bladder which can be filled with pressure medium are applicable to the method insofar as they are also to be regarded as advantageous embodiments of the method, and vice versa.

### BRIEF DESCRIPTION OF THE DRAWINGS

Exemplary embodiments of the invention will now be explained in more detail below with reference to the accompanying drawings. The drawings show:

FIG. 1 a diagrammatic depiction of a vehicle seat according to one embodiment of the invention, in which a plurality of bladders are arranged in the seat bearing surface in the region of the backrest, as actuating elements for influencing the contour of the seat bearing surface of the vehicle seat.

FIGS. 2A-2D a diagrammatic depiction of a method for producing a bladder as an actuating element for a vehicle seat according to an embodiment of the invention;

FIG. 3 a diagrammatic cross-section through a hollow body or base body shown in FIG. 2A, along axis A-A;

FIGS. 4A-4D a diagrammatic depiction of a method for producing a bladder as an actuating element for a vehicle seat according to a further embodiment;

FIG. 5 a cross-section through a bladder according to FIG. 4D along line R-R.

### DETAILED DESCRIPTION OF THE PREFERRED EMBODIMENTS

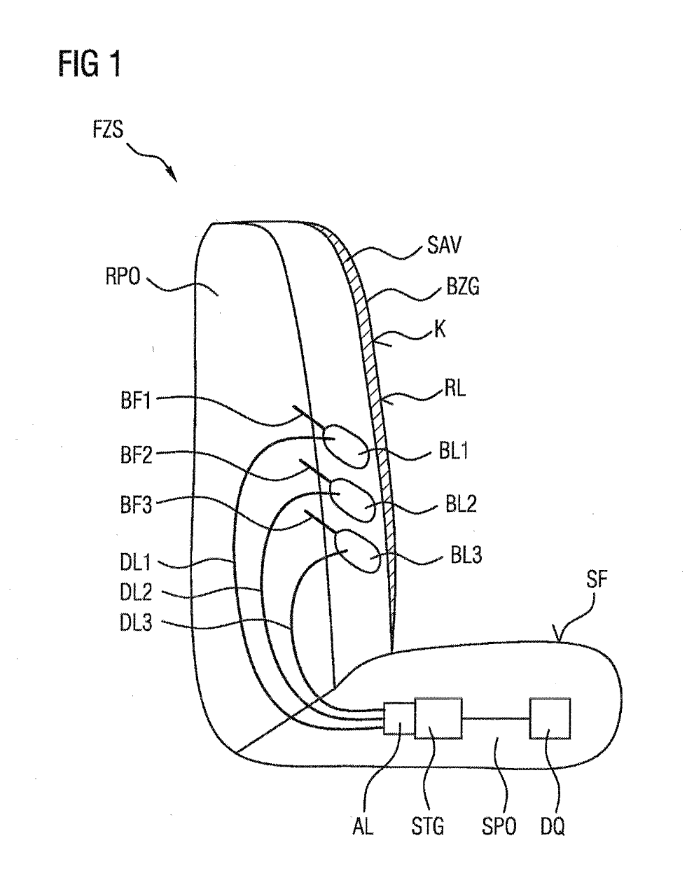

Reference is firstly made to FIG. 1 which shows a vehicle seat FZS. This vehicle seat comprises a seat cushion SPO and a backrest cushion RPO. Here a seat surface SF on the seat cushion SPO and a backrest RL on the backrest cushion RPO each form a portion of a seat bearing surface of the vehicle seat FZS. On the part of the seat bearing surface formed by the backrest, three bladders BL1, BL2 and BL3 are provided as part of an adjusting device for adjusting the seat bearing surface (in this case, the backrest RL). The three bladders are situated below a foam layer SAV which in turn is covered by a cloth or upholstery BZG. The respective bladders BL1 to BL3 are attached to the backrest cushion RPO by corresponding fixing portions BF1 for bladder BL1, BF2 for bladder BL2, and BF3 for bladder BL3. It is also conceivable that the three bladders BL1 to BL3 are attached to a carrier mat, which then cooperates with or is attached to the backrest cushion RPO. In the example shown in FIG. 1, the three bladders BL1 to BL3 serve as lumbar bladders to form a lumbar support for a vehicle occupant. It is here conceivable, instead of three bladders, to use for example only two or one bladder, or also four or more bladders for the adjusting device.

The adjusting device furthermore comprises pressure medium lines DL1, DL2 and DL3 via which the bladders BL1, BL2 and BL3 can each be connected to an adapter element AL of a control unit STG in the vehicle seat FZS. Here, the control unit STG serves for providing pressure medium such as air via a pressure medium source DQ, wherein the air may be supplied as a pressure medium to the bladders BL1 to BL3 selectively via the pressure medium lines DL1 to DL3, in particular via electropneumatic valves. Depending on the driver's request, the bladders BL1 to BL3 may be selectively inflated in order to change the contour K in the region of the lower back and provide optimal support for the occupant's back.

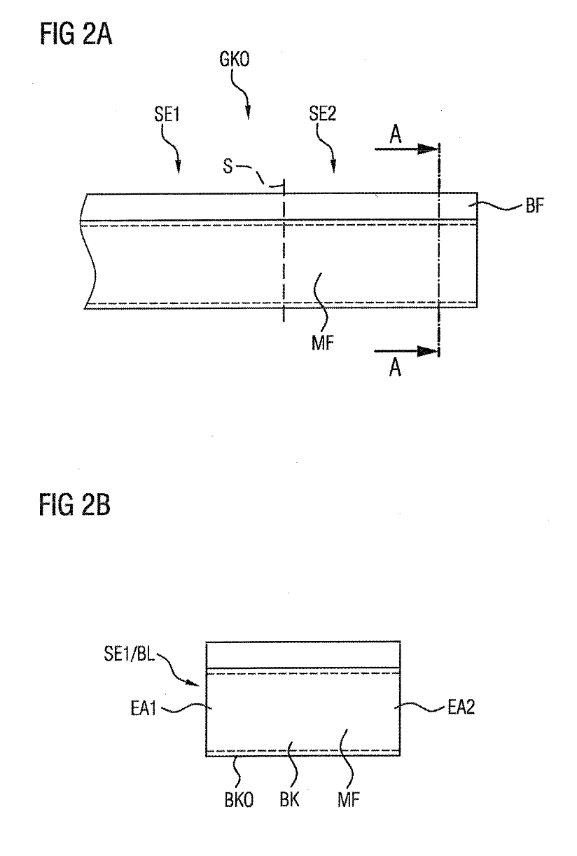

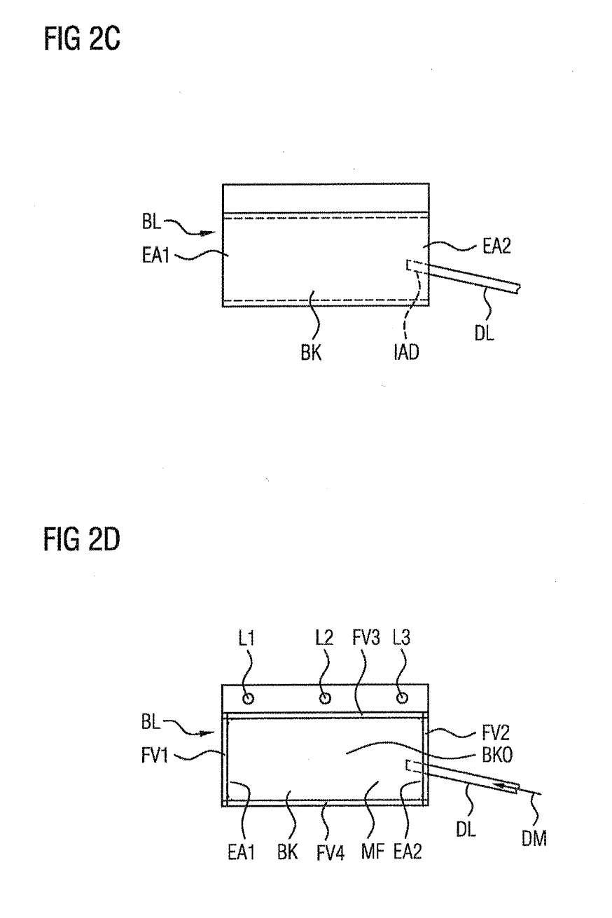

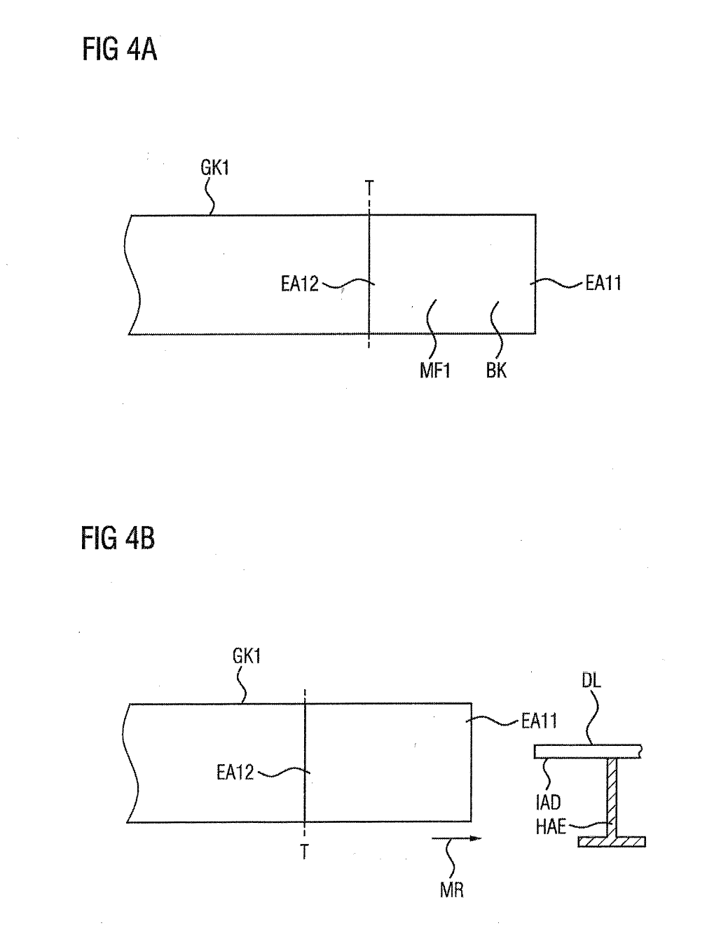

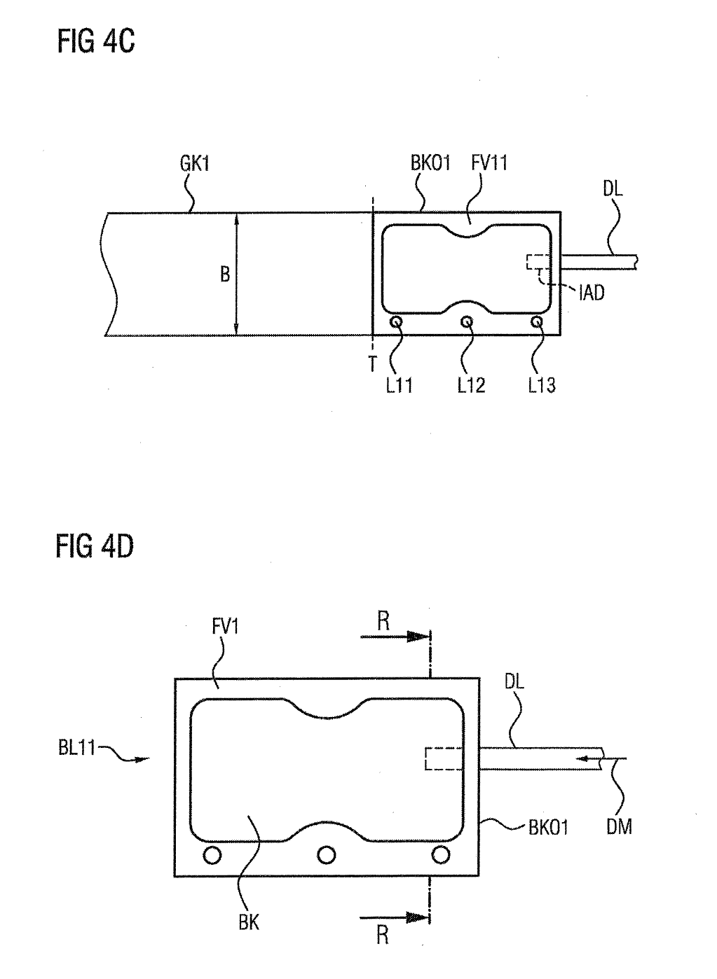

For example, bladders produced shown in FIGS. 2A-2D or FIGS. 4A-4D may be used as bladders BL1 to BL3 here. This will be explained below.

Reference is initially made to FIGS. 2A-2D which show a diagrammatic sequence of a method for producing a bladder as an actuating element for a pneumatic adjusting device of the vehicle seat. In a first step, a hose-like base body GKO is provided. This base body GKO may here be produced by means of an extrusion process. In particular, a granulate of a thermoplastic plastic as raw material is heated to a specific temperature. At this temperature, the raw material then melts and a mass is produced which is conducted via a nozzle which finally produces the desired profile of a hose-like endless' body, here the base body GKO. After passing through the nozzle, the correspondingly formed material cools so that it retains the shape given by the nozzle.

Looking at the upper portion of FIG. 2A, it is evident that the base body GKO has a fixing portion BF. As will be shown later in relation to FIG. 2D, several passage openings or holes L1 to L3 may be made in this fixing portion BF, in particular punched out. The holes may then serve as connecting elements for mounting a corresponding bladder on a vehicle seat or a corresponding carrier element.

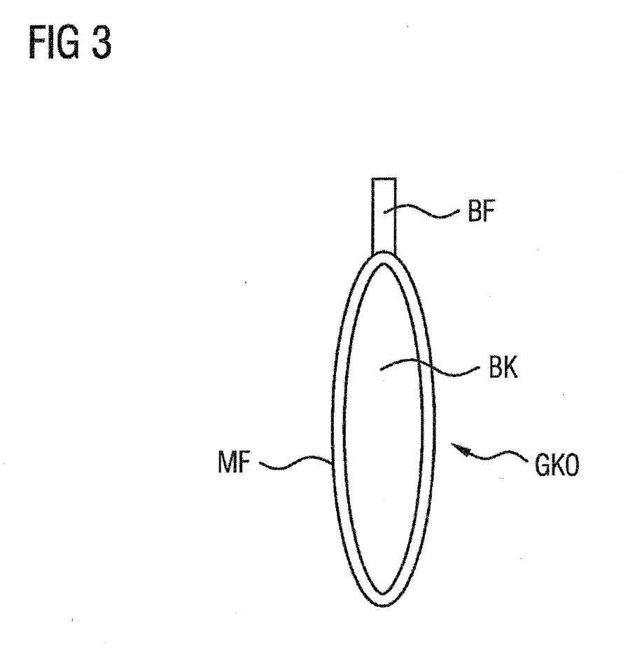

Reference is now made to FIG. 3 which shows a cross-sectional view of the base body GKO along a line A-A in FIG. 2A. The lower part shows the hose-like portion of a casing surface MF, while the upper part shows the fixing portion BF which is formed during extrusion. A chamber, later also designated the bladder chamber BK, is surrounded by the casing surface MF.

According to the method of FIGS. 2A-2D, in a second step a right-hand portion SE2 of the base body GKO is separated, in particular punched, from a left-hand portion SE1 along the line S in FIG. 2A. Thus with the right-hand portion SE1, an intermediate product of a bladder BL is produced as shown in FIG. 2B. The bladder BL now comprises a hose-like bladder body BKO with a casing surface MF which extends from a first open portion EA1 to a second open portion EA2 and encloses a bladder chamber BK.

After separation in the second step of the method, in a third step as shown in FIG. 2C, a pressure medium line DL is now introduced through one of the two open end portions, in the figure here the second open end portion EA2, such that an end portion IAD of the pressure medium line DL protrudes into the bladder chamber BK.

According to a fourth step, a first joint connection FV1 is now produced on the left or first end portion EA1, and a second joint connection FV2 on the right or second end portion of the bladder BL. In particular by means of a high-frequency welding process, the part portions of the bladder body BKO lying above each other at the first end portion EA1 and at the second end portion EA2 are now connected or welded together so as to produce a sealed bladder chamber BK. The hose-like form of the base body GKO or bladder body BKO has proved advantageous since in the simplest case, only the ends or end portions EA1 and EA2 need be closed in order to form a bladder chamber BK. It is quite conceivable that more joint connections are also produced. In particular, in a single method, it may be that by means of a correspondingly formed welding electrode, four joint connections FV1 to FV4 (i.e. also joint connections FV3 and FV4 on the upper and lower edges of the bladder chamber BK, in addition to the joint connections FV1 and FV2) are produced simultaneously. Thus the manufacturing complexity for producing a bladder BL is further reduced.

According to a further step, it is then conceivable for example to provide, in particular to punch out, holes L1 to L3 in the fixing portion BF which then serve as possible fixings to a vehicle seat.

To summarize, it can be said that according to the method in FIGS. 2A-2D, firstly hose-like bladder bodies BKO are separated from a hose-like base body GKO and then processed individually into finished bladders BL.

Reference is now made to FIGS. 4A-4D which show a diagrammatic sequence of a method for producing a bladder as an actuating device for a vehicle seat according to a further embodiment. In a first step, again a hose-like base body is produced, as has already been explained in relation to FIGS. 2A-2D. To distinguish this from the first embodiment, this hose-like base body is designated with reference sign GK1. On its right side in the figure, the base body GK1 has a first open end portion EA11. The base body GK1 extends along a casing surface MF1 into a second portion EA12. Here, a bladder chamber BK of a bladder to be produced later is enclosed inside the casing surface MF1 between the portions EA11 and EA12.

After this provision of the hose-like base body GK1 in the first step, now in a second step a pressure medium line DL is fixed to a holder HAE. Furthermore, the hose-like base body GK is moved in the direction of the arrow MR until the pressure medium line DL or an end portion IAD thereof penetrates through the first open end portion EA11 into the bladder chamber BK.

Now in FIG. 4C, in a third step a joint connection FV11 is produced so as to create a bladder chamber BK which is sealed against pressure medium or fluid. For example, a correspondingly shaped welding electrode may be applied to the right-hand portion of the hose-like base body GK1 so that, in particular by a high-frequency welding process, a joint connection FV11 is produced as shown in FIG. 4C. By producing the joint connection FV1, the end portions EA11 and EA12 are tightly closed, wherein furthermore the pressure medium line DL is also sealed against the hose-like base body GK by the connecting seam. Thus pressure medium can now be exchanged between the bladder chamber and the environment only via the pressure medium line DL. As shown in FIG. 4C, in the lower portion of the joint connection FV1, a wider joint connection portion is produced. This may be used, within the third step according to FIG. 4C or the following fourth step in FIG. 4D, to provide holes L11, L12 and L13 (in particular by punching) which may later be used as connecting elements for fixing to a vehicle seat.

After producing the joint connection FV11 (and where applicable producing the holes L11 to L13), now in a fourth step separation takes place of the portion of the base body which already constitutes a complete bladder with bladder chamber which can be filled with pressure medium. Thus according to the fourth step, the portion of the base body GK1 which lies to the right of line T is separated along said line. This line T may lie inside the joint connection FV11, along it (as shown in FIG. 4C), or outside it.

Then an autonomous bladder BL11 is created with a hose-like bladder body BKO1 which is sealed tightly against pressure medium at its ends by the joint connection, in order to create a bladder chamber BK which can be filled with a pressure medium DM via the pressure medium line DL. By filling with pressure medium, the volume of the bladder BL11 may be increased and its shape changed accordingly, so that by this shape change, a contour change can be achieved of a seat bearing surface on a vehicle seat if the bladder BL11 is arranged for example as one of the bladders BL1 to BL3 in FIG. 1.

It is again pointed out that with this embodiment for producing a bladder which can be filled with pressure medium according to FIGS. 4A-4D, in a simple manner with little manufacturing complexity, a bladder which can be filled with pressure medium may be produced as an actuating element of a pneumatic adjusting device for a vehicle seat.

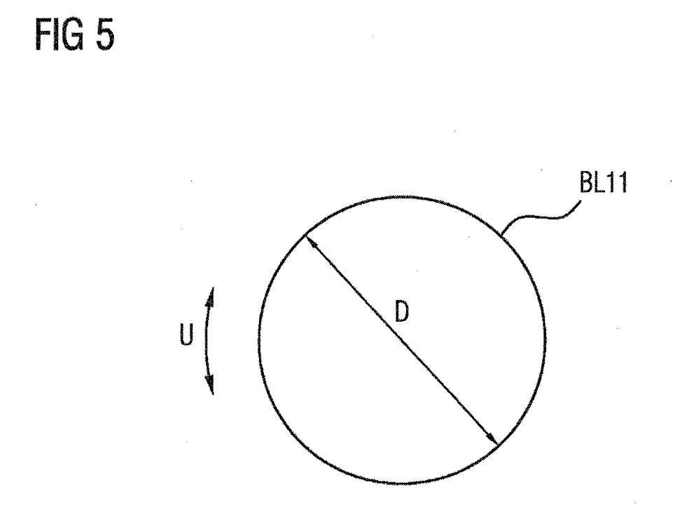

FIG. 5 again shows the bladder BL11 in a cross-sectional view along line R-R in FIG. 4D. Here, the bladder BL11 is shown in a completely filled state. Assuming that the bladder chamber here has a circular cross-section, the diameter has the (maximal) value D. This diameter is then the maximal lift which the bladder BL11 can generate when it is transferred from the fully evacuated state into the completely filled state. In order to calculate the width B of the hose-like base body GK1 in its evacuated or flattened form which is necessary to achieve the later diameter D, the following formula may be used:

The circumference U of the bladder BL11 in FIG. 5 arises from U=D*n.

Thus for the width B in FIG. 4C:

B=U/2=D*n/2.

Hence by means of this simple formula for a bladder which can be filled with pressure medium, with the purpose of having to execute a specific lift, a correspondingly wide hose-like base body GK1 may be selected. This naturally also applies to the production of a bladder according to FIGS. 2A-2D.

1. A bladder which can be filled with a pressure medium, as an actuating element for a seat comprising:
a one-piece hose-like bladder body with a casing surface which extends from a first end portion to a second end portion and encloses a bladder chamber,
at least one joint connection for closing the end portions so as to form a bladder chamber sealed against the pressure medium, and
a pressure medium line for introducing the pressure medium into the sealed bladder chamber.

2. The bladder as claimed in claim 1, wherein the pressure medium line is introduced through one of the end portions at the at least one joint connection.

3. The bladder as claimed in claim 1, wherein the at least one joint connection is a weld connection.

4. A method for producing a bladder which can be filled with a pressure medium (DM), as an actuating element for a seat comprising:
providing a one-piece hose-like bladder body with a casing surface which extends from a first end portion to a second end portion and encloses a bladder chamber,
providing a pressure medium line for introducing or evacuating the pressure medium into or from the bladder chamber, and
producing at least one joint connection for closing the open end portions so as to form a bladder chamber sealed against the pressure medium.

5. The method as claimed in claim 4, wherein on provision of the pressure medium line, the pressure medium line is introduced into the bladder chamber through at least one of the open end portions.

6. A method for producing a bladder which can be filled with a pressure medium, as an actuating element for a seat comprising:
providing a hose-like base body with a first open end portion, a second portion remote from the first open end portion, and a casing surface which joins the two portions together and encloses a bladder chamber (BK),
providing a pressure medium line for introducing or evacuating the pressure medium into or from the bladder chamber,
producing at least one joint connection for closing the first open end portion and the second portion so as to form a bladder chamber which is sealed against the pressure medium, and
separating a bladder body containing the sealed bladder chamber from the hose-like base body.

7. The method as claimed in claim 6, wherein on provision of the pressure medium line, the pressure medium line is introduced into the bladder chamber through the first open end portion.

8. The method as claimed in claim 7, wherein the pressure medium line is introduced into the bladder chamber through the first open end portion by moving the hose-like base body relative to the pressure medium line when the pressure medium line is fixed.

9. The method as claimed in claim 6, wherein the hose-like base body is formed in one piece.

10. The method for as claimed in claim 4, wherein the hose-like bladder body or the hose-like base body is produced by an extrusion process.

11. The method as claimed in claim 4, wherein the at least one joint connection is produced by welding.

12. The method as claimed in claim 4, wherein one or more passage openings are made in a region of the at least one joint connection.

13. The bladder which can be filled with pressure medium as claimed in claim 2, wherein the at least one joint connection is a weld connection.

14. The method as claimed in claim 4, wherein the at least one joint connection is produced by high-frequency welding.
